(19) United States
(12) Patent Application Publication
(10) Pub. No.: US 2008/0150685 A1
(43) Pub. Date: Jun. 26, 2008

(54) VEHICLE KEY FOR BI-DIRECTIONAL COMMUNICATION WITH VEHICLE

(75) Inventors: Tejas Bhupendra Desai, Troy, MI (US); Susan Adelle Drescher, Plymouth, MI (US); Mark D. Wallace, White Lake, MI (US)

Correspondence Address: SIEMENS CORPORATION;INTELLECTUAL PROPERTY DEPARTMENT, 170 WOOD AVENUE SOUTH, attn: VDO - CGO docketing migration, ISELIN, NJ, 08830, US

(73) Assignee: CONTINENTAL AUTOMOTIVE SYSTEMS US, INC., Auburn Hills, MI (US)

(21) Appl. No.: 12/042,358

(22) Filed: Mar. 5, 2008

Related U.S. Application Data
(63) Continuation-in-part of application No. 11/216,908, filed on Aug. 31, 2005.
Application No. 11/216,908 is a continuation-in-part of application No. 11/396,372, filed on Mar. 31, 2006.

(51) Int. Cl. G07C 9/00; B60R 25/00

(52) U.S. Cl. 340/5.61

(57) ABSTRACT

A method for bi-directional communication between a vehicle and a vehicle key includes providing a vehicle key with a connector to communicate with the vehicle, storing user data on the vehicle key, communicating with the vehicle with the vehicle key, and adjusting a plurality of vehicle settings to match the user data stored on the vehicle key responsive to communicating between the vehicle and the vehicle key.

### CROSS-REFERENCE TO RELATED APPLICATIONS

This application is continuation-in-part of U.S. application Ser. No. 11/216,908, filed Aug. 31, 2005 and U.S. application Ser. No. 11/396,372, filed Mar. 31, 2006.

### BACKGROUND OF THE INVENTION

This disclosure generally relates to a vehicle communication system, and more particularly to a vehicle key for bi-directional communication with a vehicle.

Vehicles are being provided with more and more electronic components. For example, vehicle keys are known having electronics used to enter and start a vehicle, such as through a remote keyless entry system (RKE) or a passive start and entry system (PASE).

Incorporating additional content and features into existing wireless devices would reduce the need to locate specific devices for performing specific functions. For example, one device could be responsible for a variety of functions related to the vehicle.

Today there is no efficient way to transfer data in and out of a vehicle without the utilization of additional OEM diagnostic tools and devices. Known vehicle keys also can present a vehicle security risk when transferring data. Typically, the vehicle keys do not provide a secure means for transferring data for authenticated users. Additionally, a separate device is typically required to download and transfer data in and out of a vehicle.

Accordingly, it is desirable to provide an improved vehicle key operable to achieve bi-directional communication with a vehicle without the need for additional diagnostic tools and devices.

### SUMMARY OF THE INVENTION

A method for bi-directional communication between a vehicle and a vehicle key includes the steps of providing the vehicle key with a connector to communicate with the vehicle, storing user data on the vehicle key, communicating with the vehicle key, and adjusting a plurality of vehicle settings to match the user data stored on the vehicle key responsive to communicating with the vehicle. In one example, the method for bi-directional communication between the vehicle and the vehicle key includes transferring vehicle data from the vehicle on to the vehicle key.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates an example vehicle key for communicating with a vehicle;

FIG. 2 illustrates one example connector for the vehicle key illustrated in FIG. 1;

FIG. 3 schematically illustrates bi-directional communication between a vehicle key and a vehicle; and

FIG. 4 illustrates a method for performing bi-directional communication between a vehicle key and a vehicle.

### DETAILED DESCRIPTION OF THE DISCLOSED EMBODIMENT

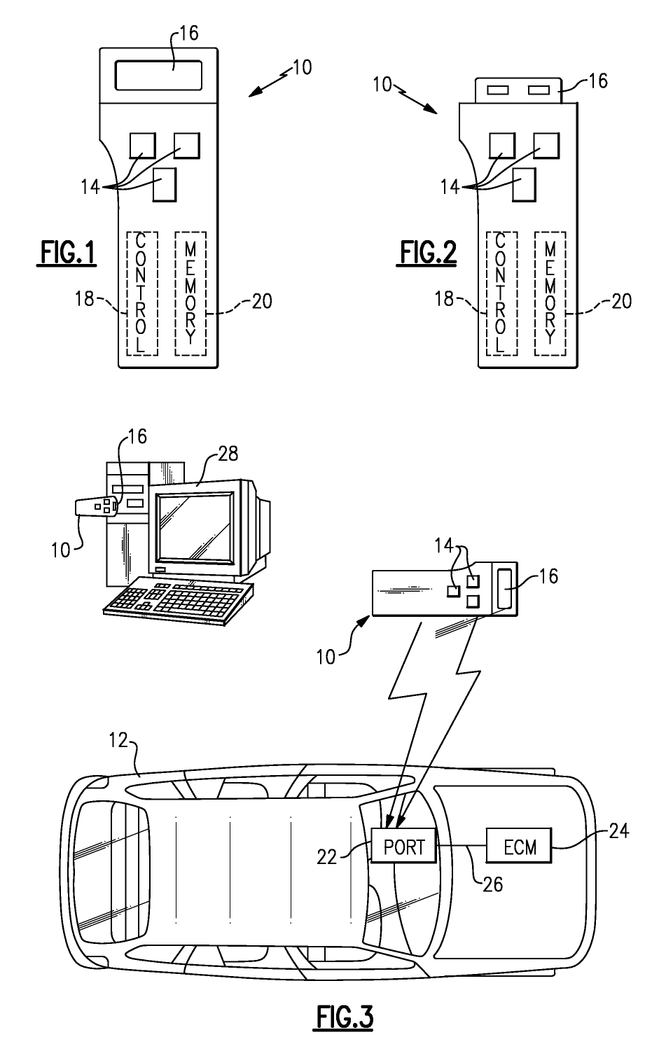

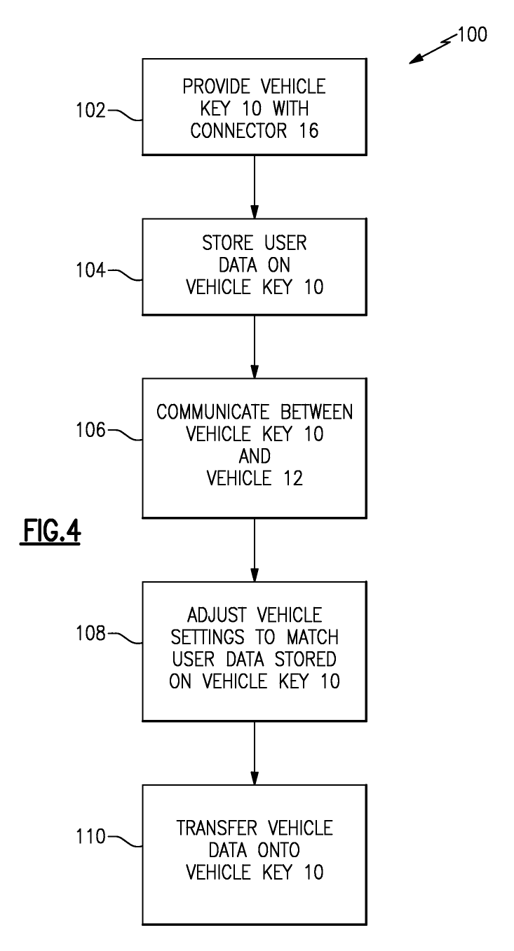

FIG. 1 schematically illustrates a vehicle key 10 for use in performing a variety of functions related to a vehicle 12 (shown in FIG. 3). For example, the vehicle key 10 includes a plurality of switches 14 that may be actuated to provide access to or unlock the door/truck, etc. of the vehicle 12 as part of a remote keyless entry (RKE) system. In addition, the vehicle key 10 may be equipped to perform passive start and entry functionality as part of a passive start and entry system (PASE). A person of ordinary skill in the art would understand that the vehicle key 10 may be equipped to be used as part of any remote signal communication system.

The vehicle key 10 includes a connector 16. In one example, the connector 16 is a USB connector (See FIG. 2). The connector 16 may include any other type of physical connection for connecting the vehicle key 10 to the vehicle 12. In another example, the connector 16 includes a wireless connection device. The wireless connection device includes Bluetooth communications, for example. A person of ordinary skill in the art would understand that any physical connection or wireless connection may be utilized to perform a data transfer between the vehicle key 10 and the vehicle 12. A person of ordinary skill in the art having the benefit of this disclosure would be able to design the vehicle key 10 to include the appropriate hardware and/or software for performing such a data transfer.

The vehicle key 10 also includes a microcontroller 18 and a memory device 20. In one example, the memory device 20 is a flash memory. The amount of memory included on the vehicle key 10 will vary depending on design specific parameters including, but not limited to, OEM specific design requirements. The memory device 20 is operable to store various amounts of data and information, such as user data associated with the vehicle, as is further discussed below.

FIG. 3 schematically illustrates the vehicle key 10 in communication with a vehicle 12 for the bi-directional communication therebetween. The vehicle key 10 is connectable to a port 22 of the vehicle 12 to provide for the bi-directional communication between the vehicle key 10 and the vehicle 12. In one example, physical connection is provided between the vehicle key 10 and the port 22. In another example, a wireless connection is provided therebetween. The port 22 is a docking station, in one example. In another example, the port 22 is a vehicle ignition.

The port 22 provides access over a bus 26 to an electronic control module (ECM) 24 on the vehicle 12. User data is stored on the vehicle key 10 and is transferred from the vehicle key 10 to the ECM 24. The ECM 24 selectively commands adjustment of a plurality of vehicle settings, for example, responsive to receiving the user data from the vehicle key 10, as is further discussed below.

The vehicle key 10 is also connectable to a home computer 28. User data and other settings stored on the home computer 28 may be transferred to the vehicle key 10 for subsequent communication to the vehicle 12. The home computer 28 is equipped with the appropriate software for storing, accessing and transferring the user data onto the vehicle key 10, for example. A person of ordinary skill in the art having the benefit of this disclosure would be able to implement the appropriate software onto the home computer 28 to perform the example exchange of user data.

FIG. 4, with continued reference to FIGS. 1, 2 and 3, illustrates an example method 100 for the bi-directional communication of data between a vehicle key 10 and a vehicle 12. At step block 102, the vehicle key 10 is provided with a connector 16 that enables the key 10 to communicate with the vehicle 12 and a home computer 28. In one example, the connector 16 provides a physical connection to the vehicle 12 and the home computer 28, such as through a USB connector, for example. In another example, the connector 16 is a wireless communication device that includes Bluetooth communications, for example.

Next, at step block 104, user data is stored on the vehicle key 10. “User data” as utilized in this disclosure is intended to include any data that may associate a user with a vehicle and/or any other data that a user may desire to access during vehicle 12 operation. In one example, the user data includes user settings including, but not limited to, personalized settings, ambient light and/or color settings, seat and mirror settings, radio settings, climate control settings, auto lock and egress settings, display options, etc. In another example, the user data includes audio and video downloads, such as music and movies, for example.

In yet another example, the user data includes navigation information that may include maps, address books, area points of interest and other related information, etc. In still another example, the user data includes phone links, including address books for hands free calling, email addresses, calendar, etc.

Further, the user data may include home access settings. For example, the vehicle key 10 may include user data related to garage access features that can learn the frequency protocol and codes of a user's garage door opener to operate entry into the garage. Moreover, lighting of the garage and surrounding areas of a user's home may also be accessed and controlled through the vehicle key 10.

Although specific examples of the user data are described herein, it should be understood that any data that may be utilized by a user in relation to the vehicle 12 may be stored onto the vehicle key 10. The home computer 28 is programmed with the necessary software to communicate the user data from the home computer 28 to the vehicle key 10 through the connector 16.

In yet another example, a plurality of services may be downloaded from the home computer 28 onto the vehicle key 10. The services include, but are not limited to, vehicle service updates, for example. In one example, the functionality of the vehicle key 10 may be upgraded by downloading additional services onto the memory device 20.

The vehicle key 10 communicates with the vehicle 12 to communicate the user data to the vehicle 12 at step block 106. The communication between the vehicle key 10 and the vehicle 12 may be achieved actively or passively. For example, the vehicle user may plug the connector 16 of the vehicle key 10 into the port 22 of the vehicle 12 to actively achieve the data exchange. In another example, passive communication is achieved by wirelessly communicating between the vehicle key 10 and the vehicle 12, such as through Bluetooth communications, for example.

In yet another example, the vehicle key 10 is multi-car configurable. That is, the user data and other information stored on the vehicle key 10 may be accessed by other authorized vehicles. In this way, a user is required to carry only a single device for any of a multitude of authorized vehicles.

Next, at step block 108, a plurality of vehicle settings are adjusted to match the user data stored on the vehicle key in response to step block 106. For example, the ECM 24 of the vehicle 12 reads the user data stored on the vehicle key and adjusts the user settings to match the user data responsive to command signals communicated by the ECM 24. For example, where specific user settings such as seat and mirror settings are read by the ECM 24, the ECM 24 commands the vehicle seat and mirrors to the appropriate setting. A person of ordinary skill in the art having the benefit of this disclosure would understand how to program the ECM 24 to communicate the appropriate commands for adjusting the vehicle settings in response to reading the user data from the vehicle key 10.

Finally, at step block 110, specific vehicle data from the vehicle may be transferred to the vehicle key 10. For example, vehicle diagnostics may be communicated from the vehicle 12 to the vehicle key 10. The stored vehicle diagnostics may be transferred to the home computer 28 through the connector 16 and subsequently communicated over the internet to a car dealership, for example, to provide analysis of the diagnostic information of the vehicle 12. It should be understood that any type of information associated with the vehicle 12 may be transferred to and stored on the memory device 20 of the vehicle key 10

The foregoing description shall be interpreted as illustrative and not in any limiting sense. A worker of ordinary skill in the art would understand that certain modifications would come within the scope of this disclosure. For these reasons, the following claims should be studied to determine the true scope and content of this disclosure.

What is claimed is:

1. A method for bi-directional communication between a vehicle and a vehicle key, comprising the steps of:
a) providing the vehicle key with a connector to communicate with the vehicle;
b) storing user data on the vehicle key;
c) communicating with the vehicle with the vehicle key; and
d) adjusting a plurality of vehicle settings to match the user data stored on the vehicle key responsive to said step c).

2. The method as recited in claim 1, wherein the connector is a USB connector.

3. The method as recited in claim 1, wherein the connector is a wireless communication device.

4. The method as recited in claim 1, wherein said step a) includes the step of:
providing the vehicle key with a memory device and a plurality of switches to actuate signals to be transmitted to the vehicle.

5. The method as recited in claim 1, wherein said step b) includes the steps of:
communicating between the vehicle key and a home computer through the connector; and
transferring the user data from the home computer onto the vehicle key.

6. The method as recited in claim 5, wherein said step b) includes the step of:
downloading a plurality of services onto the vehicle key subsequent to connecting the vehicle key to the home computer.

7. The method as recited in claim 1, wherein said step c) includes the steps of:
plugging the connector of the vehicle key into a port of the vehicle.

8. The method as recited in claim 1, wherein said step c) includes the step of:
wirelessly communicating between the vehicle key and the vehicle.

9. The method as recited in claim 8, wherein the wireless communication is achieved through Bluetooth communications.

10. The method as recited in claim 1, wherein the user data includes at least one of a plurality of user settings, navigation information, audio and video downloads, home access data and phone links.

11. The method as recited in claim 1, wherein said step d) includes the step of:
reading the user data with an electronic control module on the vehicle; and
adjusting a plurality of user settings to match the user data responsive to command signals communicated by the electronic control module.

12. The method as recited in claim 1, comprising the step of:
e) transferring vehicle data from the vehicle onto the vehicle key.
